(19) United States
(12) Patent Application Publication
(10) Pub. No.: US 2019/0363498 A1
(43) Pub. Date: Nov. 28, 2019

(54) ELECTRICAL CONNECTOR SYSTEM

(71) Applicant: VOLTRICS LTD, Droitwich Worcestershire (GB)

(72) Inventors: Greg COX, Droitwich Worcestershire (GB); David FOWLER, Droitwich Worcestershire (GB)

(21) Appl. No.: 16/479,413

(22) PCT Filed: Jan. 17, 2018
(86) PCT No.: PCT/GB2018/050126

§ 371 Date: Jul. 19, 2019

(30) Foreign Application Priority Data
Jan. 20, 2017 (GB) 1701044.8
Sep. 29, 2017 (GB) 1715871.8

(51) Int. Cl. H01R 35/04; H01R 13/66; H01R 13/24; B25J 19/00; B25J 17/02

(52) U.S. Cl. CPC H01R 35/04; H01R 13/665; B25J 17/0275; H01R 13/2478; B25J 19/0029; H01R 13/2442

(57) ABSTRACT

A disclosed electrical conductor includes a ball part having a first electrical component and a socket part having a second electrical component. The ball and socket parts are connected together to allow movement relative to one another. The ball part includes at least one groove spaced around its surface that is electrically connected to the first electrical component by an electrical contact. The socket portion is electrically connected to the second electrical component. Most of the length of the electrical contact is located outside of the ball part so that rotation of the ball-and-socket joint is allowed with the contact riding over the ball part. A free end of the contact has an inwardly extending part that is constrained to move within the groove and to be forced against a conductive strip, to thereby establish an electrical connection between the first electrical component and the second electrical component.

### CROSS REFERENCE TO RELATED APPLICATIONS

This application is a national stage entry under 35 U.S.C 371 of PCT Patent Application No. PCT/GB2018/050126, filed Jan. 17, 2018, which claims priority to United Kingdom Patent Application No. 1701044.8, filed Jan. 20, 2017, and United Kingdom Patent Application No. 1715871.8, filed Sep. 29, 2017, the entire contents of each of which are incorporated herein by reference.

### FIELD OF THE DISCLOSURE

This disclosure relates to an electrical connector system, in particular a moving joint connecting two terminals or other electrical components so as to permit movement of the terminals relative to each other.

### BACKGROUND

Electronic devices such as portable MP3 players or smartphones with data and music storage and playback options are popular and commonly used devices. A user listens to the audio from their device via a pair of headphones or ear buds that are connected to the device via a cable, or connect the device to speakers or a computer or laptop, the cable terminating in a jack or other connector that plugs into a socket in the device. The disclosed embodiments are applicable to connectors of this type and many others.

It is common for the cable to be moved in various directions whilst setting up and/or during use. In addition a user may wrap the cable around the device for storage convenience when they are not using the device, to prevent it from trailing and snagging on other items. A user normally leaves the jack still connected into the socket when they wrap the cable, and almost invariably, as the cable is wrapped around the body of the device the cable pulls on the jack body and exerts a force at a sideways angle to the body and the cable connection. Frequently, this causes damage to the plug, socket and/or the cable connection and can render the device unusable. This is inconvenient and expensive.

The applicant disclosed in WO 2016/009365 a ball- and socket arrangement with arcuate longitudinal contacts on the outside of the ball and the inside of the socket, there being conducting balls between the inner and outer contacts maintaining an electrical connection between the two parts.

Reference may also be made to the following patent publications. Korean Patent Application KR 20030040804 (Jean) describes and shows an audio plug intended to prevent loose contact by having a freely moving terminal part that prevents the audio plug from being pulled out from a jack. A ball base is fixed at a rear end of a terminal part; US published application no. 2013/0108098 (Qin) shows an earphone that includes a headset plug and an earphone cord connecting to the headset plug with a protector located around the junction of the headset plug and the earphone cord. U.S. Pat. No. 7,234,963 (Huang) shows a USB connector with a cable rotating seat, and UK Patent GB 302 012 (Harden) discloses a ball having contacts round the circumference and a contact at the base.

This disclosure is a development of the earlier application and claims to provide an improved movable electrical connection to accommodate various uses, such as for scanning cameras and robotic arms, and storage options without causing damage to the terminals or compromising the electrical connection.

### SUMMARY OF THE DISCLOSURE

An electrical connector according to the appended claims is disclosed.

It has been found, first, that contact can be maintained between the inner and outer contacts even without the use of ball bearings, the outer contact impinging directly on the corresponding inner contacts (or vice versa) by virtue of a raised part or contact shoe. The raising (i.e. deformation or extension towards the other contact) can be the result of a thickened portion or a bent strip portion, for instance. It has also been found possible to add a degree of freedom of movement to a system of this kind by adding a circumferential track or tracks connected to the longitudinal ones.

One of the terminals can be a plug or socket. In this way the electrical connector is capable of being connected to an array of devices and/or systems. The other terminal can be a cable extending from the electrical connector and having a plug or socket arranged at the other end, thereby spacing apart the terminal connection from the electrical connector. The electrical connector may be used to provide an audio, data or power connection, or a combination. Alternatively, one or both terminals can be included within the device itself, connected to an electrical device such as a camera or actuator. Such a system can be applied to a robotic arm joint, for instance.

Advantageously, as the angle defined between the first and second terminals is changed the associated connected portions received by the terminals such as the cable, plug and or socket and the associated devices, such as headphones, a smartphone or any other electrical device, can be freely positioned so that the electrical connector is off-axis whilst still maintaining an electrical connection. This permits devices that have a fixed location or restricted access to be readily connected and easily maneuvered with reduced likelihood of damage.

The first and second body parts are formed of a male ball portion and a female socket portion; this provides a simple mechanism which is easy to produce and which can be formed in suitable sizes and shapes. Preferably the female socket portion is configured to partially envelop the male ball portion when connected.

Ideally the female socket portion has a rim that defines an edge against which the terminal arranged on the male ball portion can abut in use thereby defining the boundary of the range of movement permitted by the electrical connector. The rim may be smooth and planar or may include recessed sections or undulations configured to receive the terminal, cable; plug and/or socket arranged on the male ball body so as to permit a greater range of movement in predefined directions. The rim may be formed by a separate part fixed to the main socket portion, to make assembly easier.

The first and second body parts are configured to move in a similar manner to a constant-velocity joint such as a Rzeppa® joint, so as to permit constant movement whilst also maintaining an electrical connection. Such mechanisms can be suitably configured for this use and allow free rotation with unbroken contact.

Typically the electrical connector may include at least three, often four, bearings and three or four corresponding electrical connector grooves in order to permit audio, power and/or data transmission. However, the number of bearing contacts and grooves can be scaled up or down in order to accommodate different electrical connections, for example permitting the electrical connector to be suitable for power cables. In some embodiments the electrical connector has eight conductive bearings. This number has been found to provide optimal rotational and contact qualities.

The male ball portion has a plurality of grooves spaced around its outer face for receiving the bearing contacts or shoes held by the socket. Typically each groove extends from the terminal longitudinally along part of all of an arc around the surface of the male ball portion. In some embodiments the grooves may be arranged also to extend latitudinally or radially, so as to permit rotation about an axis of the terminal, for example to allow the plug, socket and/or cable to swivel.

The contacts on the ball portion can be in the form of a conductive material lining each groove in the ball portion, or a solid metal strip or compound strip shape, lying in the groove. The conductive strip connects to the first terminal so as to permit connection to the terminal by the conductive bearing. Typically the conductive material is attached the terminal by a pin that passes through the wall of the male ball portion to a cavity within which a wire connects the pin to the terminal, e.g. by soldering.

The electrical contact arranged on the inner face of the female socket section is connected to the second terminal and via the bearing contacts to the conductive material of the first terminal, thus establishing a connection between the first terminal and the second terminal. In use the contacts are biased against each other so as to permit a constant electrical connection from the first terminal to the second terminal.

The male ball portion may be formed as two halves that are fitted together. The grooves may be lined after the two halves are connected so as to ensure the conductive material provides a continuous layer for the ball bearing to travel along for an improved connection. Advantageously this permits access to parts within the cavity during manufacture and fabrication.

The grooves are linked together in pairs so that one pin may be used to connect two grooves to the terminal. Typically two grooves may be linked at one end wherein the pin is arranged at the joining section. For example, the two grooves may be arranged in a U-shaped or V-shaped configuration.

The arrangement of the ball bearings in the grooves allows movement of the first and second body parts relative to each other by tilting of the ball-and-socket joint: sliding of the bearings permits movement of each bearing shoe along a groove in which it is located and also permits the electrical contacts to move over each other so as to permit movement in plural directions that allows the terminals to be at various angles relative to one another whilst maintaining a constant electrical connection by the bearing.

In some embodiments the female socket portion further includes a contact crown comprising a plurality of elongate electrical contacts, each corresponding to a groove, and at least one conductive bearing arranged in or abutting against each groove and able to move freely along the length of the groove. The contact crown may include a ring arranged about the terminal from which each of the elongate electrical contacts extends. The ring may connect to a corresponding annular groove on the male ball portion so as to permit rotation whilst maintaining an electrical connection.

As with the contacts on the ball part, the elongate electrical contacts on the socket may be linked together so that a single pin is provided for connection of both contacts to the terminal. The pair of electrical contacts may be configured as U-shaped or V-shaped.

In some embodiments the electrical connector may have one electrical contact comprising a substantially hemispherical dome that covers the inner face of the female socket portion so as to provide a single electrical contact that can engage with all bearings.

The electrical contact(s) is/are sprung so as to be biased against the groove in use, thus aiding in maintenance of a constant connection to ensure that the connection is not broken during movement.

In some alternative embodiments the grooves and electrical contact are provided in a reverse arrangement wherein the grooves are provided on the inner face of the female socket and the electrical contact(s) are provided on the male ball portion.

The electrical connector can be a sealed unit having a protective outer layer coving the part of the ball that would otherwise be exposed. In this way all component parts are protected to prevent damage and ingress of dust or moisture that may compromise the electrical connection. The protective outer layer is flexible so as to easily deform during movement arising from pivoting of the connector. For example, the protective outer layer may be formed from rubber. Ideally the protective outer layer is connected to the rim of the female socket portion.

The ball and socket portions can be made from a lightweight, strong durable material such as synthetic polymer material. Ideally all the polymer components may be injection-molded with electromagnetic shielding to protect the system from interference.

Some examples of the terminal include a headphone plug, headphone socket, Universal Serial Bus (USB) plug, USB socket, Deutsches Institut für Normung (DIN) plug or socket. The headphone jack may be a 3.5 mm jack plug. This is a standard size for portable audio devices. Alternatively the plug connector may include a USB plug. The diameter of the electrical connector may be at least 7.5 mm and in some more robust embodiments may be at least 10 mm. It is clear that the electrical connector may be scaled up or down depending upon requirements and the type of connection.

The or each terminal can be configured to connect to circuitry or devices, such as actuators, within the ball part or socket part itself, no external connection or terminal being required. Thus the disclosure is also directed to jointed devices with an electrical connection across the joint for signals and/or power, or both.

In some embodiments the electrical connector may include a locking mechanism to prevent movement between the body parts, as needed. In this way the body parts can be arranged in a particular configuration and then locked in position so as to prevent movement in use. For example the socket may include a displaceable projection that can be extended from an inner face of the socket so as to engage with a ball portion in order to prevent movement.

In a further embodiment of the disclosure a further degree of freedom of movement is afforded by the equatorial grooves in which the ball contacts move. This allows the two parts to rotate with respect to each other about their common axis, in addition to rotation or tilting of the axis with respect to each other.

Such constructions are useful for applications with integrated actuators and can be used in multiple industries, from consumer electronics to robotics and prosthetics and the defense and rail industries, for instance. It addresses the problems that smaller robotic systems and prosthetics are having with high flexibility in tight packaging constraints, and that are increasingly required in, for example, medical, industrial & defense applications

Embodiments of the disclosure will now be described, by way of example only, and with reference to the Figures, as follows:

### BRIEF DESCRIPTION OF THE FIGURES

FIG. 1 shows an overview of an electrical connector having a protective outer layer, representing a first embodiment of the disclosure;

FIG. 2 shows a view of the electrical connector shown in FIG. 1, from slightly below;

FIG. 3A shows a cross section of the electrical connector shown in FIG. 1;

FIG. 3B shows a similar cross-section but rotated by 90°;

FIG. 3C is a sectional view of the connector in the tilted configuration;

FIG. 4A shows a view of the ball portion of the electrical connector;

FIG. 4B shows a top view of the ball;

FIG. 5 shows an exploded view of the electrical connector;

FIG. 6 is a perspective view of a second embodiment of the electrical connector;

FIG. 7 shows a top view of the electrical connector plug of FIG. 6;

FIG. 8 shows a section of the electrical connector of FIGS. 6 and 7;

FIG. 9 shows a third embodiment of the connector, allowing axial rotation;

FIG. 10 illustrates an application of embodiments of the disclosure as a camera;

FIG. 11 shows details of a camera in section;

FIG. 12 shows an application in a robot arm;

FIG. 13 shows an exploded view of an electrical connector;

FIG. 14 shows a cross-sectional view of the connector of FIG. 13 in a neutral position;

FIG. 15 shows a cross-sectional view of the connector of FIG. 13 in a deflected position;

FIG. 16 shows a socket having a plurality of spring arms; and

FIG. 17 shows a view of a spring arm of FIG. 16.

### DETAILED DESCRIPTION OF THE FIGURES

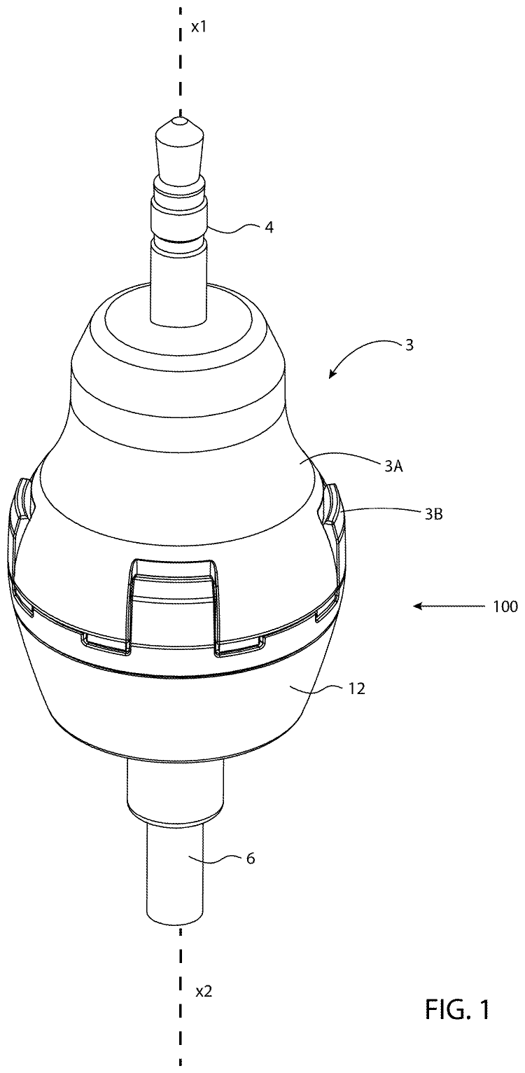

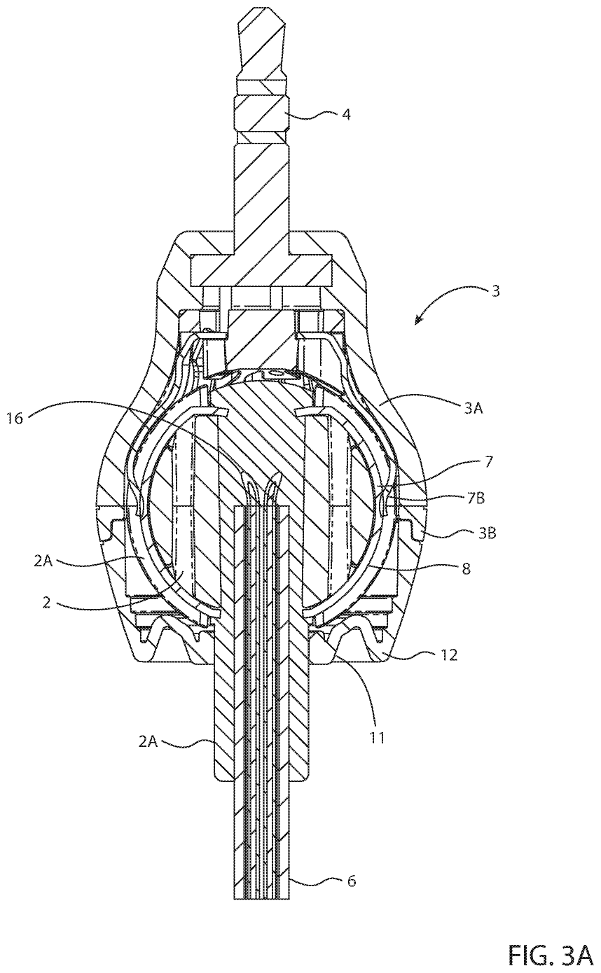

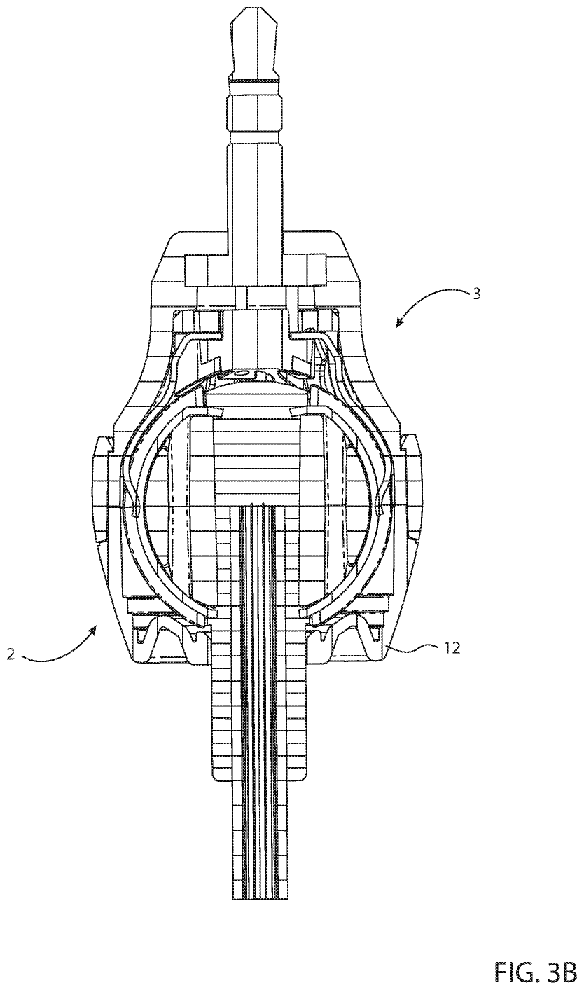

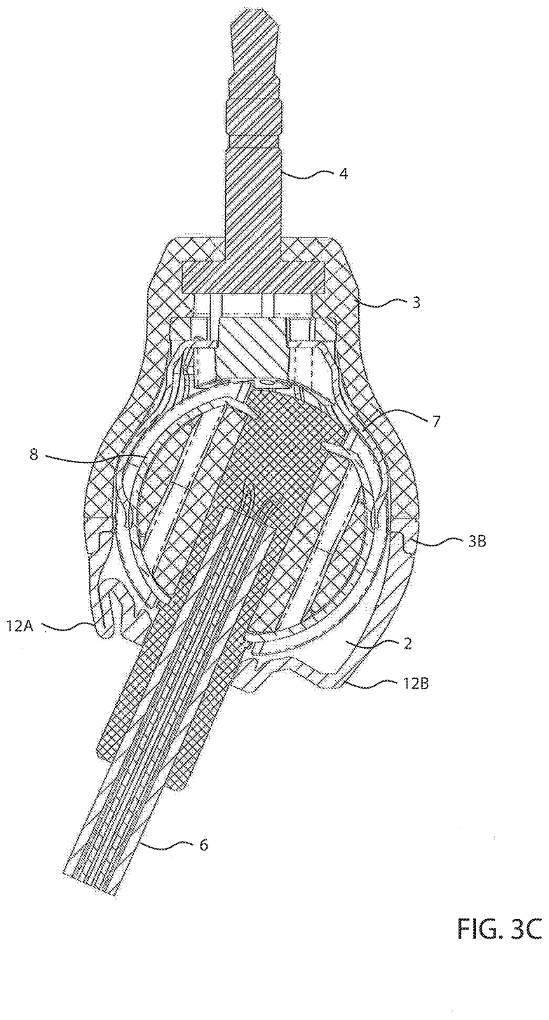

FIGS. 1 to 5 show a first embodiment of the disclosure in the form of an electrical connector 100. This connector is generally spherical; the body is formed from two parts, a male ball portion (shown in FIG. 3) and a female socket portion 3. The female socket portion is generally hemispherical, at least internally, so as to partially encase the male ball portion. Two terminals 4, 6 are provided on the electrical connector 100.

The female socket portion is connected to a protective outer layer 12 so as to seal the electrical connector 100, enclosing the ball. The protective outer layer is here formed from rubber, having a series of concentric ridges or folds 11 that allow the protective outer layer readily to flex and fold as the position of the terminal 4 is changed.

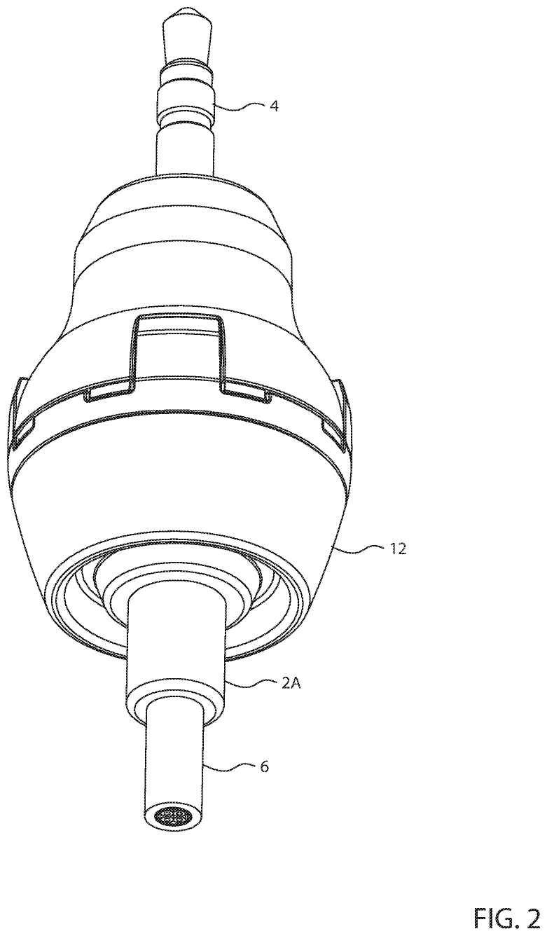

In FIGS. 1 and 2 the axes X1, X2 of the terminals 4, 6 are shown aligned. The external parts of the assembly are visible, namely the plug 4 representing one terminal, the socket 3 formed of main portion 3A and closure part of rim 3B, the cover 12 and the cable 6 representing the other terminal.

FIGS. 3A and 3B shows cross sections of the electrical connector 100. The male ball portion 2 is held inside the socket 3 by the rim 3B, the only protruding part being a sleeve 2A which passes through the cover 12 of the assembly, surrounding the cable 6. Other than the electrical circuit parts, all parts are made of plastics or rubber. The ball portion 2 is in the form of a finned sphere and thus has grooves for receiving conductive tracks 8, connected to respective wires 16 in the cable 6. The fins or side walls 2B contain these tracks 8, along which contacts 7 on the socket can run, as described below.

The male ball portion 2 sits concentrically within the female socket portion 3. The female socket portion 3 is hemispherical, or slightly over, and thus with the rim 3B encases more than half of the male ball portion 2, holding it captive.

The inner face of the female socket portion 3 has a plurality of electrical contacts or “wipers” 7 extending from the other terminal 4, i.e. the plug. The electrical contacts 7 are connected to the respective tracks of this terminal. There are eight such electrical contacts 7 provided as four connected pairs that correspond to the eight contacts 8. In as alternative to inwardly bent wipers, other inwardly protruding designs may be used, such as barrel bearings, brushes, tapered roller bearings and embedded hemispherical bearings in the wiper surfaces.

The wipers 7 extend mostly outside of the envelope of the ball part (defined mainly by the walls 2B), so that they do not inhibit its rotation. Only at the free ends of the wiper contacts 7 do they extend radially inwardly into the outline of the ball, between respective pairs of walls 2B. In this example the wipers are similarly bent inwardly at 7B, but they could be formed to extend inwardly or to be thicker at their ends, for instance.

FIG. 3C is a view similar to FIG. 3A, illustrating the configuration with the axes inclined with respect to each other. It can be seen that the protective layer or cover 12 is compressed on one side 12A and extended on the other 12B, while still sealing the internal mechanism. It can also be seen that the wipers 7 have travelled up their respective tracks 8, towards the cable 6 on one side and away from it on the other, but still maintaining electrical contact.

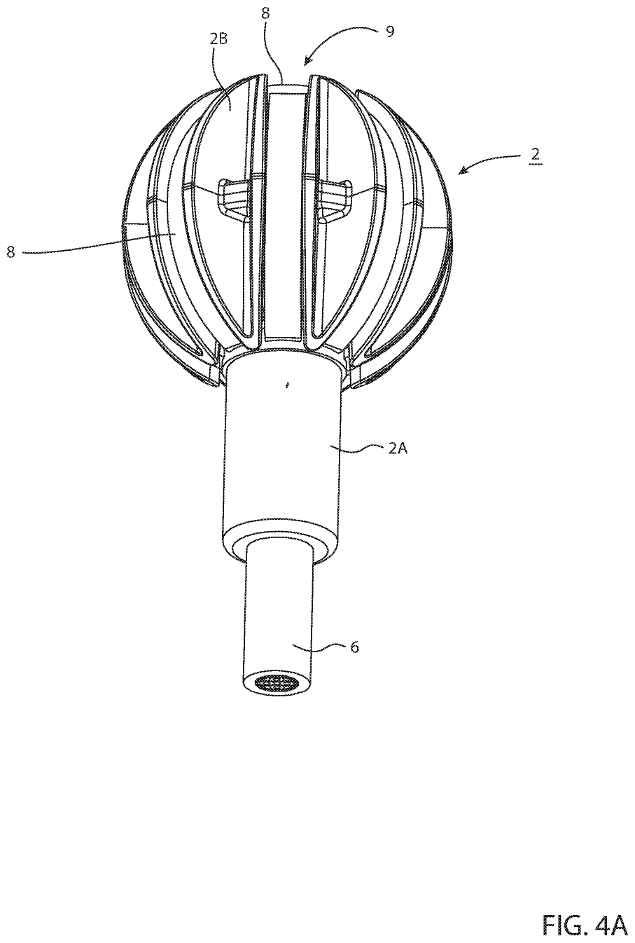

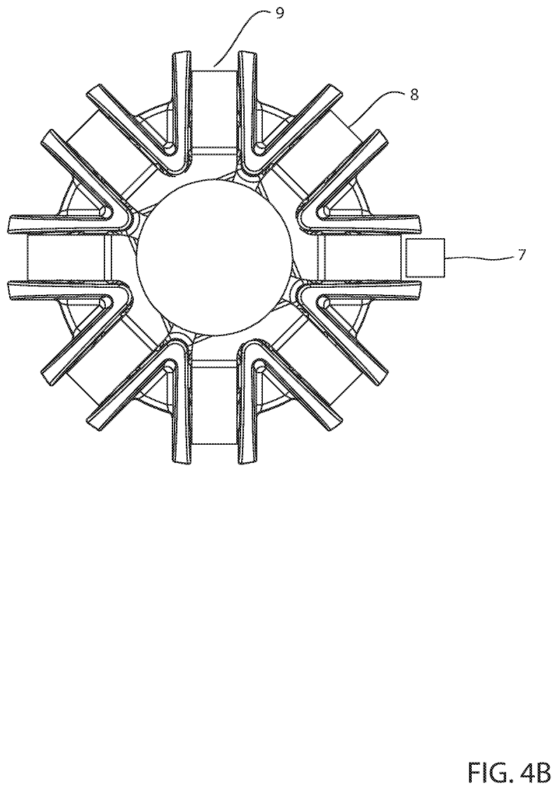

FIGS. 4A and 4B show views of the male ball portion 2 on its own. The outer face of the male ball portion 2 includes eight tracks 8 of conductive material. These are arranged as four connected pairs, residing in adjacent grooves formed by the walls or fins 2B. It can be seen that the grooves are considerably deeper than the tracks 8 lying in them, so that a contact protruding inwardly into the groove is constrained to move along it when the joint tilts. The arms of the contacts or wipers 7 are thus urged together as they travel nearer the poles of the ball, and they flex to accommodate this movement.

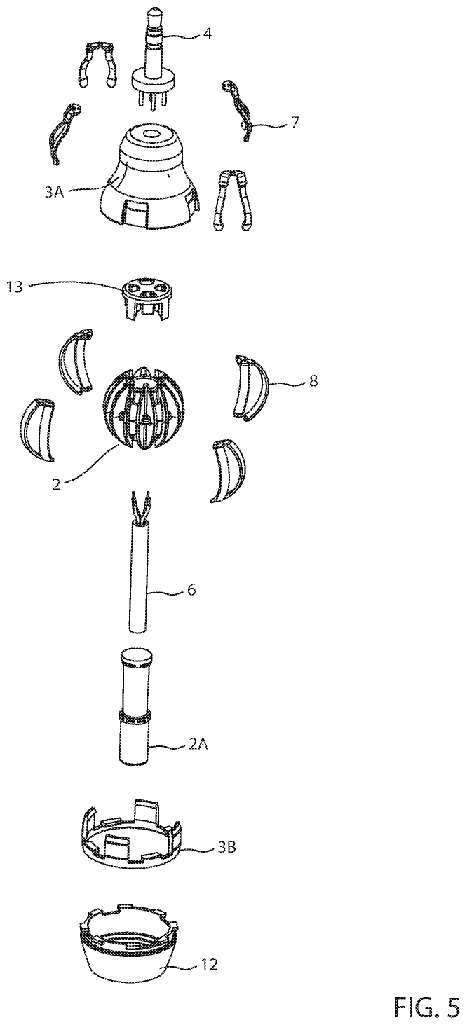

FIG. 5 shows an exploded view of the electrical connector 100 shown in FIGS. 1 to 4.

Each electrical contact pair 7 in the socket is mounted in the socket 3 at a proximal end by a molding 13, and the distal ends are free. The electrical contacts 7 are sprung so as to be biased towards the contacts 8 of the ball part. The proximal end of each electrical contact pair 7 is connected to a wire 16 which connects to the terminal 4. The electrical contacts 7 are formed from a conductive metal, alloy or metal composite.

The protective layer 12 connects to the socket 3 so as to form a sealed unit. In some embodiments this seal may be watertight so as to prevent ingress of water and therefore providing a waterproof electrical connector wherein each terminal is also provided with a watertight seal.

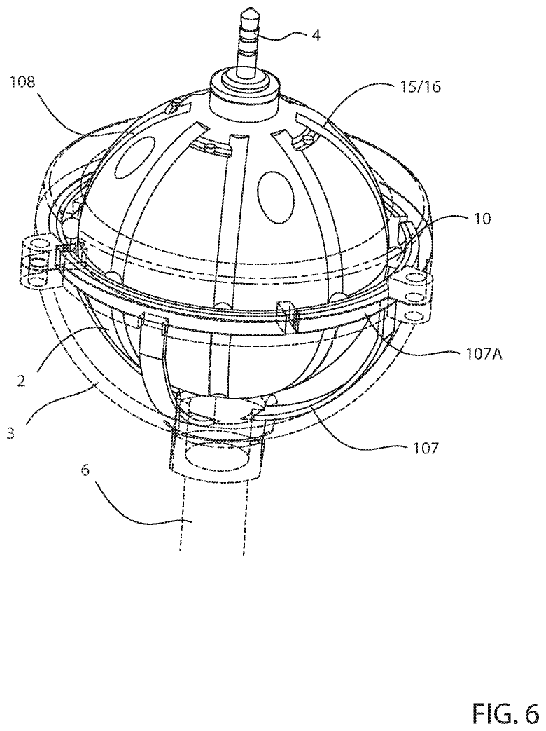

A second embodiment of the disclosure will be explained with reference to the electrical connector shown in FIGS. 6 to 8. This embodiment is similar to those shown in the applicant's earlier application WO 2016/009365. In this regard, contacts between the two systems 7 and 8 are facilitated by intermediate balls 10. However, instead of there being eight outer contacts matching the eight lined grooves on the ball, there are only four longitudinally extending outer contacts, here labelled 107, but they are connected to four quadrant pieces 107A extending circumferentially with slight gaps between them so as to surround the equator of the ball 2′. Each of these pieces holds two balls 10 for making contact to the lined grooves, here 108, and the outer assembly can rotate with respect to the inner part about their common axis by perhaps 45°, without losing the electrical contact.

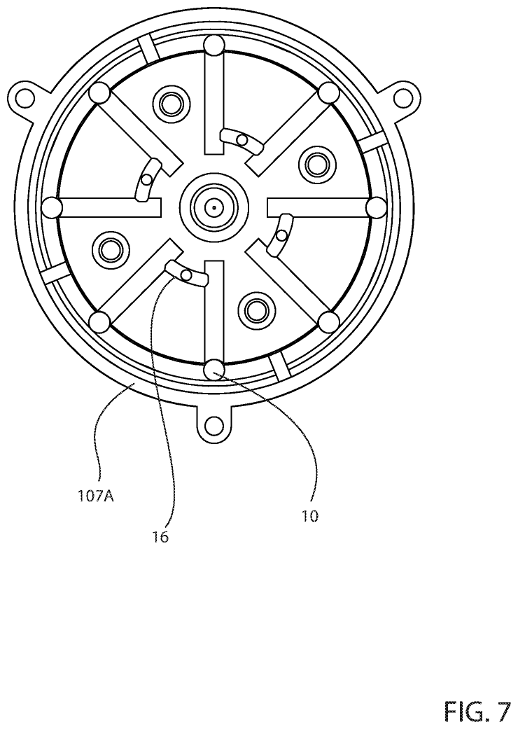

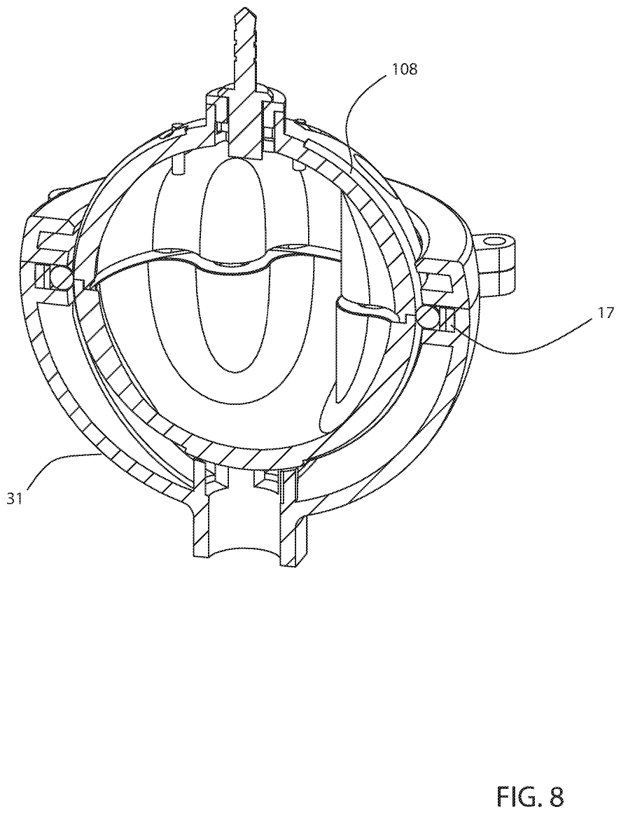

FIG. 7 shows a top view looking down on the ball, illustrating the trapped ball bearings 10 and the four holes 15 for making connection between the tracks 108 and the elements of the jack plug 4. FIG. 8 shows a section of the ball 2′ with its two halves held together by screws or a snap connection, and also a section through two diametrically opposite ball bearings 10 trapped in the internally facing channel shape of the equatorial tracks 107A of the contacts. It will also be seen that the ball bearings 10 are held tightly against the lined grooves 108 of the ball by foam pads 17 in the channels, though other urging devices such as springs are also conceivable.

The channels are closed at the circumferential ends to retain the balls 10. The joint can accommodate axial rotation until the respective ball hits the end of the channel in each direction. As the joint tilts, the balls travel towards each other within their respective channels as they approach the poles of the ball.

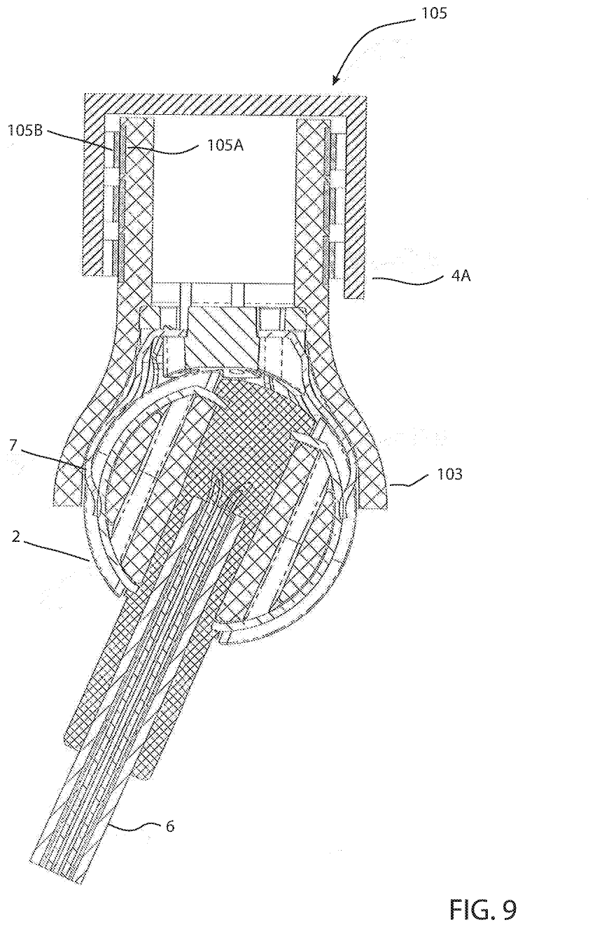

A variant embodiment, also aiming to add freedom of rotation about the connector axis as well as about a radial axis, is shown in FIG. 9. This embodiment adds a slip ring assembly 105 at one end of the connector. Other reference numerals are as in FIG. 3A, apart from the modified socket part 103, which here has three slip rings 105A axially spaced along its base section, in contact with corresponding rings 105B on the inside of a plug section 4A, shown here schematically as a generally cylindrical form. This plug section might have a jack extending from it, as in FIG. 3, or other connector, but this is not shown. The wipers 7 are connected to the respective slip ring contacts 105A by internal tracks, again not shown.

The slip ring assembly 105 allows the cable 6 to rotate about its axis with respect to the plug 4A (or other terminal or cable), contact being maintained by the slip rings of the assembly 105. At the same time the tilting action of the ball-and-socket assembly 2, 3, allows a mutual inclination of the axes of cable and plug.

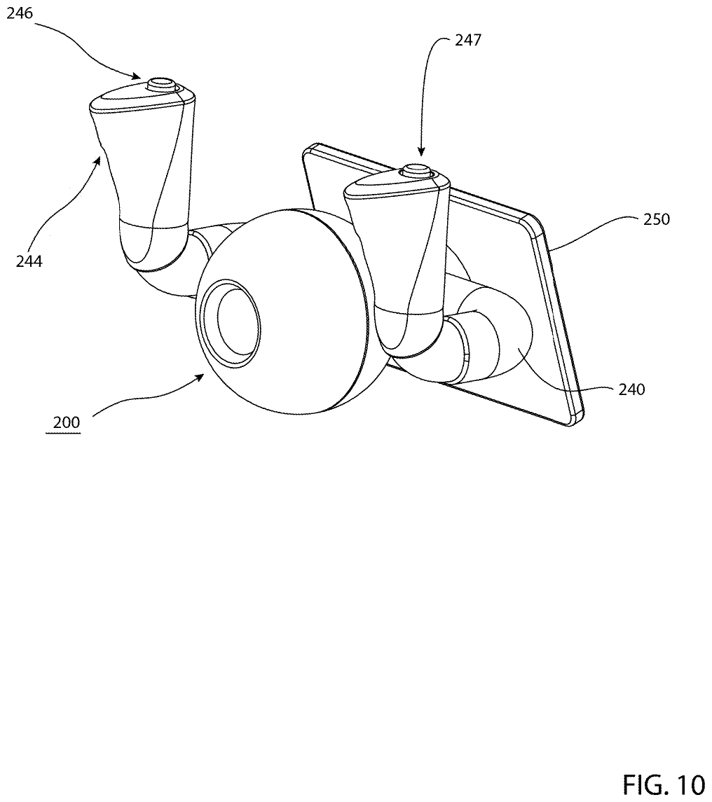

FIG. 10 shows a joint in accordance with the disclosure applied to a frame-mounted camera. The ball camera 200 is fitted to a control mount 240 from which it can be dismounted to allow external docking for charging. The operator holds the control mount 240 by way of twin joysticks 244 in the manner of bicycle handlebars, the grips having buttons 246, 247 for camera/video function and zoom control, for instance. A touch-screen display 250 is also fitted, and a memory slot can also be incorporated. Inside the ball of the camera, or possibly in the mount, or both, are actuators, controlling the movement of the camera, for instance to compensate for camera shake or in response to stored programs. The mount incorporates the socket of the ball-and-socket connector, and the ball itself includes the camera, the electrical connections passing via the ball-and-socket joint.

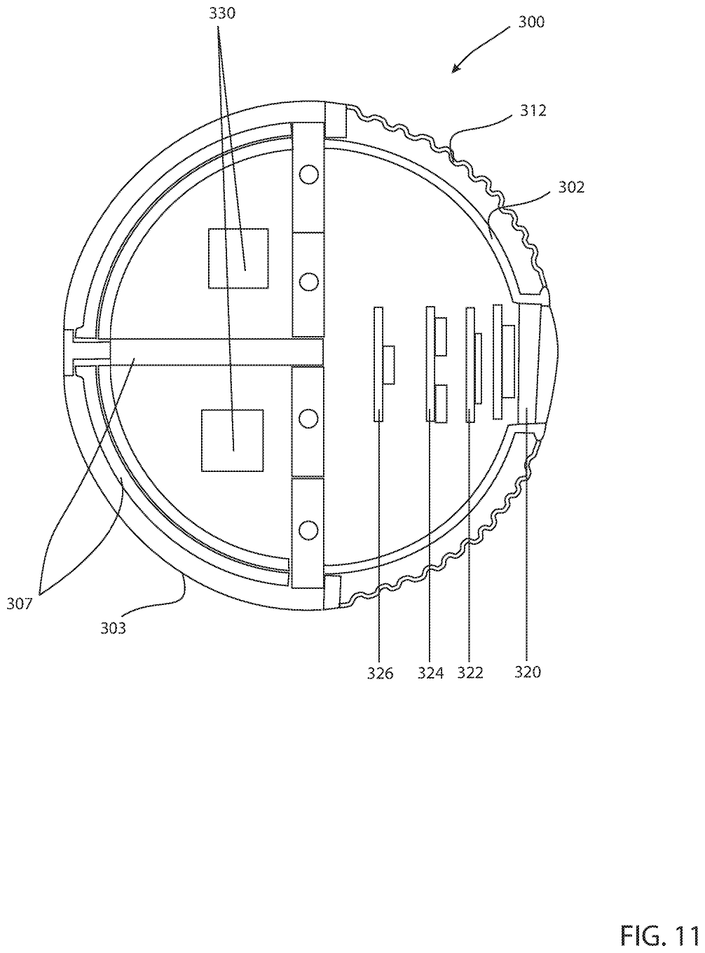

FIG. 11 shows a similar camera 300 and illustrates the possible arrangement of the internal components, partly in section. The ball 302 and socket 303 of the connector system are similar to those described previously. The tracks on the ball, which connect to the circuitry of the camera, are not shown, but the strips 307, 307A in the socket are shown, as are motors and actuators 330 located inside the cavity of the ball 302. The moving parts are protected by a cover 312 of elastomer.

A lens 320 at the “front” of the ball, i.e. opposite the socket, focuses light onto an image sensor 322, which in turn is controlled by a motherboard 324. A wireless device 326 may also be included for transmitting the sensor signals to be processed elsewhere. The camera can have an external housing, not shown, which can contain actuators and/or memory and battery components.

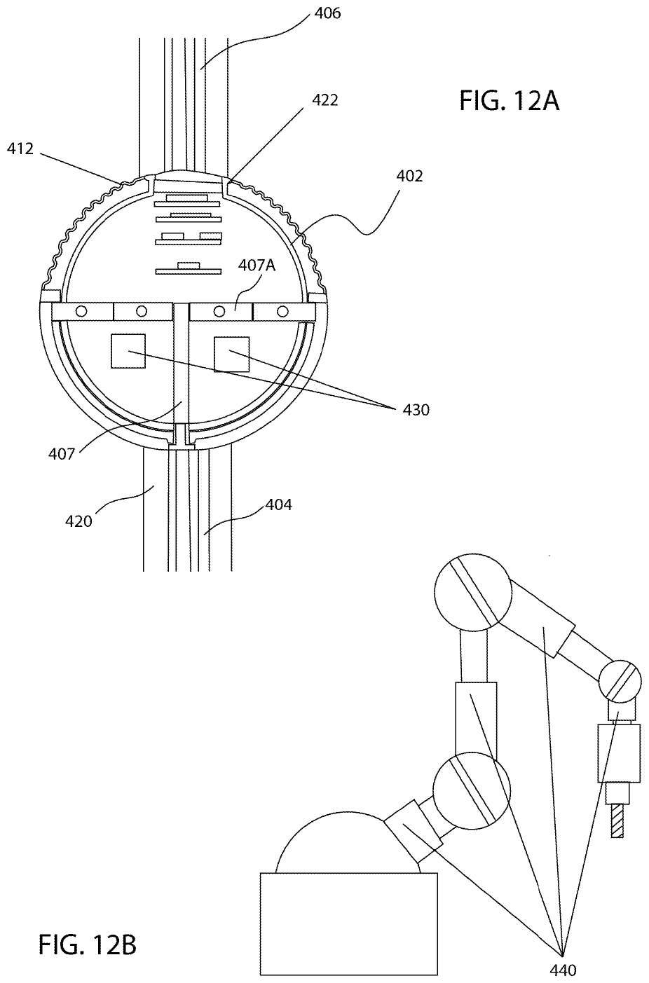

FIG. 12A shows a further application of embodiments of the disclosure in the context of actuators such as robotic arms. Here two arm sections 420, 422 are connected by a ball-and-socket connector 400 in accordance with the disclosure. The arm sections contain cables 404, 406 carrying power and signals to the connector and to be transmitted further down the arm. The socket 403 includes T-shaped longitudinal/radial tracks 407, 407A as before; and the ball 402 has grooved tracks as before, not shown. The ball contains motors/actuators 430 for bending the joint. As shown in the view of FIG. 12B, such actuators can also be located in a housing 440 external to the joint itself.

The applications just described use electrical joints of the second type, with the additional circumferential ball race for rotation about the line of contact, but they could instead use the simpler version with just the tilting action, either with sliding contacts as described or including ball bearings.

An example robot arm includes: a joint formed of two arm sections connected by a ball and socket connector; and motors and/or actuators for bending the joint.

An electrical connection is maintained between a first electrical component and a second electrical component by contact between a conductor on the outer surface of the ball and a conductor on the inner surface of the socket.

Optionally, the robot arm includes an electrical connector of any of the types described herein.

The arm sections may contain cables for carrying power and signals to the connector and for transmission further down the arm.

Optionally, the socket includes T-shaped longitudinal/radial tracks and the ball has grooved tracks.

The ball may contain the motors and/or actuators or the motors and/or actuators may be located in a housing external to the joint.

As will be appreciated from the description above, the connection allows relative rotation of the first and second electrical components about more than one axis whilst maintaining an electrical connection therebetween.

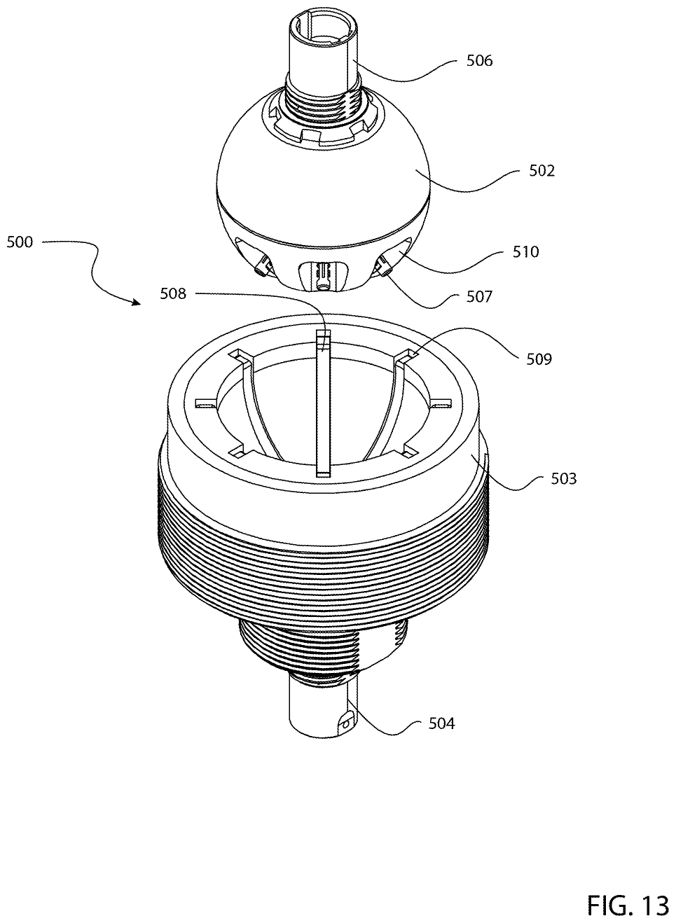

The embodiments set out above provide conductive strips in one or more grooves on the ball part 2 and at least one electrical contact on the socket part 3. However, the alternative arrangement is possible, as shown in the embodiment of FIG. 13.

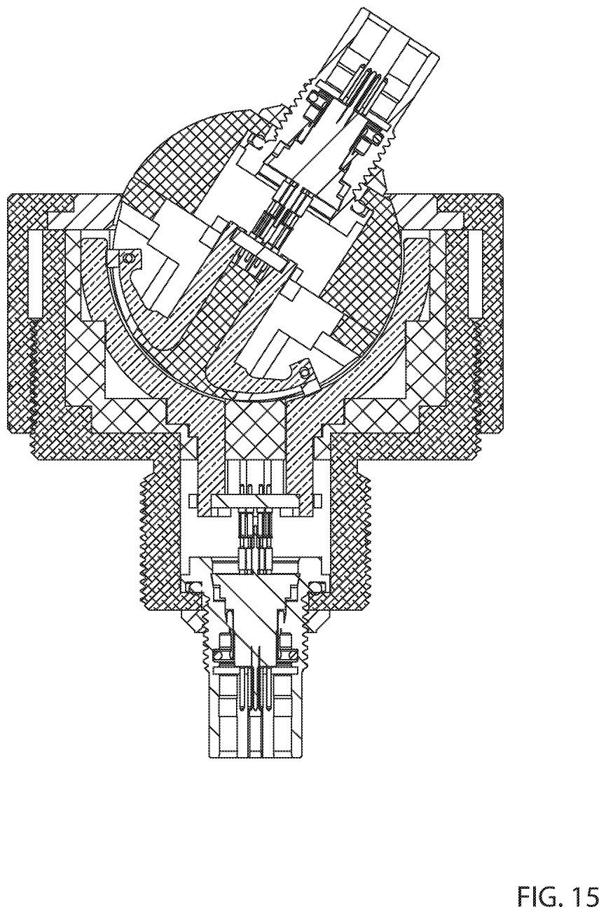

In FIGS. 13 to 15, the ball part 502 has a first electrical component 506 (in this example, the first electrical component 506 may be a plug or socket, but also could be the end of a wire where it meets the ball part 502).

The socket part 503 has a second electrical component 504 (in this example, the second electrical component 504 may be a plug or socket, but also could be the end of a wire where it meets the ball part 502).

The socket part 503 includes one or more electrical contacts 508 in the form of one or more conductive track(s) 18. The conductive track(s) 508 lie within a/respective groove(s) 509 formed in the inner surface of the socket of the socket part 503. The conductive track(s) 508 are thus arc-shaped and lie in a spherical surface.

The ball part 502 and socket part 503 form a joint that allows rotation about the centroid of the spherical surface.

The ball part 502 includes one or more electrical contact(s) 507 in the form of a set of conductive wipers (these could also be referred to as followers). The one or more electrical contact(s) 507 extend outwardly from the ball part 502. The electrical contact(s) 507 may each contact a respective one of the conductive tracks 508 to form electrical connections. The electrical contact(s) 507 extend into the grooves 509 to thereby be held in alignment with the conductive tracks 508.

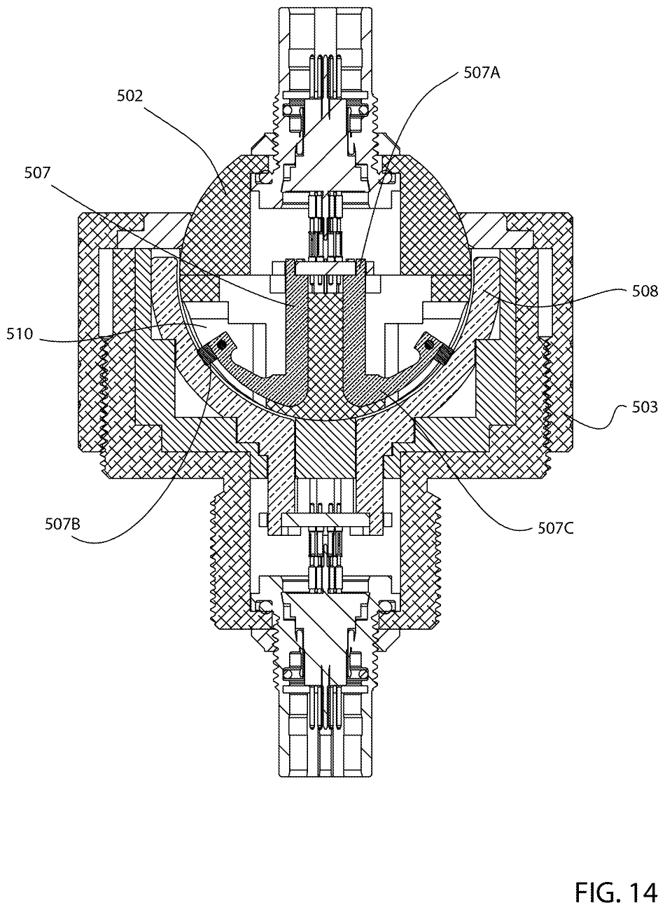

As can be seen from FIG. 14, the electrical contact(s) 507 are in the form of arms 507c extending from a mounting point 507a within the ball 502 to a contact tip 507b that protrudes outwardly through an opening 510 in the ball 502.

In the embodiments given above, the electrical contact(s) of each part 2, 3, 502, 503 may be equally spaced around the longitudinal axis of the respective part.

In the embodiments described above, the wipers 7, 507 are spring arms. These may be deflected from their equilibrium position in the assembled connector. In this way, they can be urged into contact with the conductive tracks 8, 508.

Alternatively, or in addition, the spring arms may be resilient to allow them to flex, but to urge them towards respective equilibrium positions. In this way, the spring arms, when provided as part of the socket part 3, may apply an inward gripping force to the ball 2. When provided as part of the ball 503, the spring arms may apply an outward force to the socket 503. That is, the resilience of the spring arms may assist the retention of the ball 2, 502 within the socket 3, 503.

Furthermore, the inventors have realized that the resilience of the spring arms may allow an amount of lateral movement (i.e. about the longitudinal axis of the part 3, 502 having the spring arms) of the point of contact between the wipers 7, 507 with the conductive tracks 8, 508.

This can allow a greater angular range of rotation of one part relative to the other.

Whilst the inwardly bent wipers 7 described above can be cantilevered and so have some inherent flexibility, the inventors have discovered that the design of the spring arms may be improved by the provision of additional length thereto.

In the embodiment in which the electrical contact(s) 507 are in the form of arms that extend from a mounting point 507a within the ball 502 to a contact tip 507b that protrudes outwardly through an opening 510 in the ball 502, the arms 507c have a length greater than the straight line distance between the mounting point 507a and the contact tip 507b.

In the embodiment in which the wipers 7 form part of the socket 3, the wipers 7 have a length greater than the geodesic distance around the ball 2 to the point of contact.

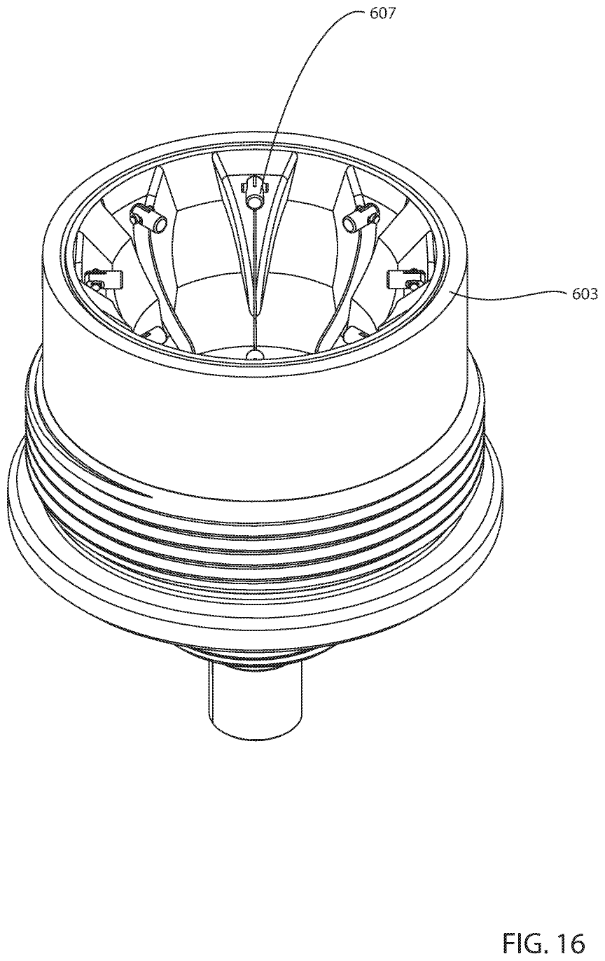

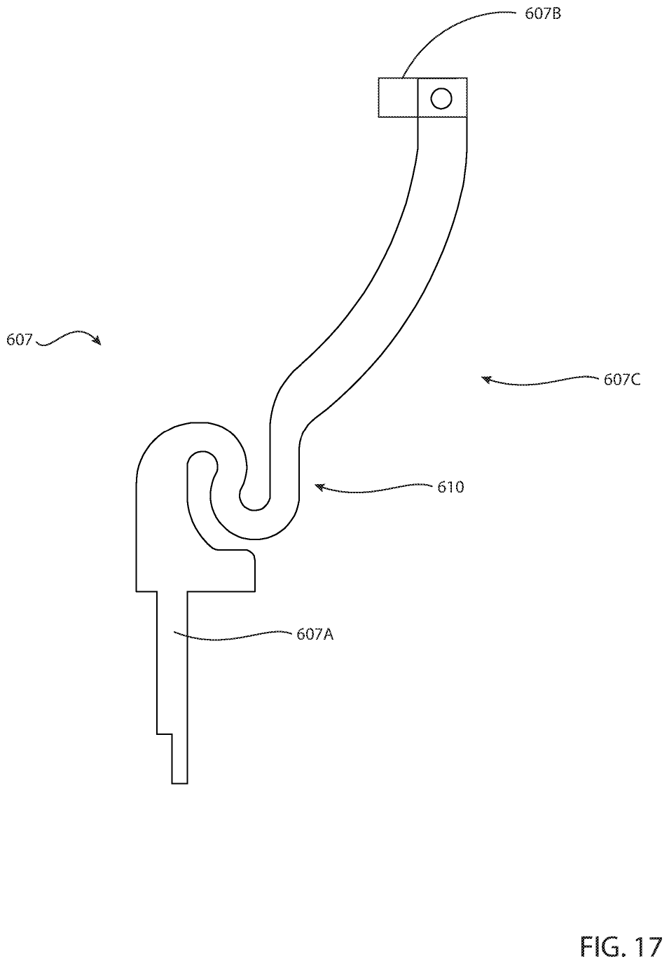

Preferred wipers 7 are shown in FIGS. 16 and 17. FIG. 17 shows a spring arm 607 suitable for use as a wiper 7 in the embodiment of FIG. 3A. As can be seen from FIG. 17, each spring arm 607 may include a mounting point 607a defined at the proximal end of the arm 607 (the end to be mounted to the body of the socket part 3) and a contact tip 607b defined at the distal end (the end intended to contact the groove 9 and conductive track 8 of the ball part 2), with an arm body 607c extending therebetween. The spring arm 607 is cantilevered from the mounting point 607c and is thus free to flex along the full length of the arm body 607c.

The arm body 607c is formed as a strip. The strip has a length that extends from the mounting point 607a to the contact tip 607b. The strip has a width, which extends radially with respect to the ball or socket. The strip has a thickness, perpendicular to its width and length.

The width of the strip may be greater than its thickness. In this way, the gripping strength of the m 607 can be retained, whilst allowing lateral movement.

Irrespective of whether the arm body 607c is provided as a strip, the arm body 607c may include a portion 610 (a narrowed portion 610), where the width of the arm 607 in the radial direction of the ball or socket is reduced. This can allow increased flexibility of the arm 607.

Alternatively, or additionally, the arm body 607c may include a portion 610 (a spring portion 610), where the arm 607 includes multiple bends in a plane that includes the longitudinal direction of the ball or socket and extends radially therefrom. This can allow increased resilience of the arm 607, since the bending of the arm 607 as a whole will occur over a longer length of arm and thus lead to less work-hardening over time.

FIG. 16 shows a plurality of such arms 607 forming a socket 603.

Irrespective of the particular construction, in each type of connector described above, an electrical connection can be maintained by conduction between a conductor on the outer surface of the ball member and a conductor on the inner surface of the socket member.

Reference numerals

| | | | |
|---|---|---|---|
| | | 11 | Folds |
| 2, 202, 302 | Male ball portion; | 12, 312, 412 | Outer (protective) |
| | 2A: sleeve; 2B: walls | | layer |
| 3, 103A, B; | female socket section, | 13 | Mounting |
| 303, 403 | parts 3A, 3B; 3D: rim | | |
| 4 | Terminal/plug | 14 | Solder pin |
| 5 | | 15 | Hole for pin |
| 6 | Terminal/cable | 16 | Wire |
| 7, 107, | Electrical contacts; | 17 | Pads |
| 307, 407 | 7B: bent ends | | |
| 8; 108 | Contact strips; | | |
| 9 | Grooves | 200 | Camera |
| 10 | Ball bearings | 240 | Mount |
| 100 | connector | | |
| X1, X2 | Axes | 320-326 | Camera components |
| 105 | Slip ring assembly | 330, 430 | actuators |

1. An electrical connector, comprising:
a first part having a first electrical component; and
a second part having a second electrical component,
wherein one of the first and second parts forms a ball part and the other of the first and second parts forms a socket part, the ball and socket parts being connected together and configured to allow movement with respect to each other thereby permitting variable angles to be defined between an axis of the first electrical component and an axis of the second electrical component,
wherein the first part comprises one or more grooves spaced around a surface of the first part, the one or more grooves being lined with or including a conductive strip connected to the first electrical component, and the second part comprises one or more electrical contacts, the one or more electrical contacts arranged to extend into a respective groove of the first part and being connected to the second electrical component, and
wherein the one or more electrical contacts are constrained to move within the respective groove and are urged against the conductive strip of the groove, so as to establish an electrical connection between the first electrical component and the second electrical component.

2. The electrical connector of claim 1, wherein each of the one or more electrical contacts is a cantilevered arm.

3. The electrical connector of claim 1, wherein each of the one or more electrical contacts is a spring arm.

4. The electrical connector of claim 3, wherein each of the one or more electrical contacts is flexible radially with respect to the ball and/or socket for providing a retaining force to hold the ball within the socket.

5. The electrical connector of claim 3, wherein each of the one or more electrical contacts is flexible laterally with respect to the ball and/or socket.

6. The electrical connector of claim 3, wherein the spring arm comprises a strip.

7. The electrical connector of claim 6, wherein:
the strip has a width extending radially with respect to the ball or socket;
the strip has a thickness perpendicular to its width; and
the width is greater than the thickness.

8. The electrical connector of claim 2, wherein the arm comprises a narrowed portion.

9. The electrical connector of claim 8, wherein the arm comprises a narrowed portion in which a width of the arm in a radial direction of the ball or socket is narrowed.

10. The electrical connector of claim 2, wherein the arm comprises multiple bends in a plane that includes a longitudinal direction of the ball or socket and the arm extends radially therefrom.

11. The electrical connector of claim 1, wherein:
the second part forms the ball part and the first part forms the socket part; and
the one or more electrical contacts are each in a form of an arm that extends from a mounting point within the ball part to a contact tip that protrudes outwardly through an opening in the ball part, the arm configured to contact the conductive strip of a groove of the socket part.

12. The electrical connector of claim 11, wherein each of the one or more electrical contacts is in a form of an arm that has a length greater than a straight line distance between the mounting point and the contact tip.

13. An electrical connector, comprising:
a ball part having a first electrical component;
a socket part having a second electrical component, the ball and socket parts being connected together to allow movement with respect to each other thereby permitting variable angles to be defined between an axis of the first electrical component and an axis of the second electrical component;
wherein the ball part includes at least one groove spaced around a surface of the ball part, the at least one groove being lined with or containing a conductive strip connected to the first electrical component, and the socket part including at least one electrical contact arranged on an inner surface of the socket portion and being connected to the second electrical component,
wherein most of a length of the at least one electrical contact is located outside of the ball part so that rotation of the ball-and-socket joint is allowed by the at least one contact riding over the ball part,
wherein towards its free end the at least one contact has an inwardly extending part constrained to move within the at least one groove and the inwardly extended part is configured to be urged against the conductive strip, so as to establish an electrical connection between the first electrical component and the second electrical component.

14. The electrical connector of claim 13, wherein the inwardly extending part of the contact strip is formed: by bending the strip, by the free end being thicker than a remainder of the strip, by having a captive contact ball or stud, or by incorporating a brush contact.

15. The electrical connector of claim 13, further comprising two or more electrical contacts and corresponding conductive strips.

16. The electrical connector of claim 15, wherein the two or more contacts and/or corresponding conductive strips are connected together in pairs, the contacts or strips of each pair being connected together at a head end near a respective electrical component, with elements of the pair diverging as the elements extend around the ball part.

17. The electrical connector of claim 1, wherein the ball part is constructed with longitudinal walls extending in radial planes so as to define the grooves between the radial planes.

18. The electrical connector of claim 1, wherein the ball part or the socket part further includes a sliding contact assembly, allowing relative rotation between the first and second electrical components about an axis of the connector.

19. An electrical connector, comprising:
a ball part having a first electrical component;
a socket part having a second electrical component, the ball and socket parts being connected together to allow movement with respect to each other thereby permitting variable angles to be defined between an axis of the first electrical component and an axis of the second electrical component; and
a conductive ball,
wherein the ball part includes at least one groove spaced around a surface of the ball part, the at least one groove being lined with or containing a conductive strip connected to the first electrical component, and the socket part including at least one electrical contact arranged on an inner surface of the socket part and being connected to the second electrical component,
wherein the electrical contact includes a track extending circumferentially from the socket part to the ball part, and
wherein the conductive ball is configured to be held between the track and the at least one groove and to be urged against the conductive strip, so as to establish an electrical connection between the first electrical component and the second electrical component.

20. The electrical connector of claim 19, further comprising:
two or more groves; and
a second conductive ball that is held between the track and the two or more groves,
wherein there are twice as many grooves with conductive strips as electrical contacts.

21. The electrical connector according to claim 1, wherein the first or second electrical component is a plug or a socket.

22. The electrical connector of claim 1, further comprising:
a plurality of conductive ball bearings,
wherein the socket part includes a female portion that includes a contact crown having a plurality of elongate electrical contacts, each electrical contact corresponding to a groove, and
wherein at least one of the plurality of conductive ball bearings is provided in each groove, and the ball bearings are configured to move along each groove so that an electrical contact is maintained during movement of either of the first and second parts.

23. The electrical connector of claim 1, wherein each electrical contact further includes a spring that forces the electrical contact against the contact strips.

24. The electrical connector of claim 1, wherein the socket part includes a female portion has a rim that is planar or castellated.

25. The electrical connector of claim 1, further including a protective outer layer protecting the otherwise exposed surface of the ball part.

26. The electrical connector of claim 1, wherein one of the first or second electrical components is a headphone jack plug.

27. The electrical connector of claim 26, wherein the headphone jack is a 3.5 mm jack plug.

28. The electrical connector of claim 1, wherein one of the first or second electrical components is a USB plug or socket.

29. The electrical connector of claim 1, further comprising a locking mechanism to lock relative movement of the first and second parts.

30. A jointed electrical device, comprising:
an actuator for tilting the joint; and
an electrical connector for connecting with the actuator across the joint, the connector comprising:
a first part having a first electrical component; and
a second part having a second electrical component,
wherein one of the first and second parts forms a ball part and the other of the first and second parts forms a socket part, the ball and socket parts being connected together to allow movement with respect to each other thereby permitting variable angles to be defined between an axis of the first electrical component and an axis of the second electrical component,
wherein the first part includes one or more grooves spaced around a surface of the first part, the one or more grooves being lined with or including a conductive strip connected to the first electrical component, and the second part including one or more electrical contacts the one or more electrical contacts configured to extend into a respective groove of the first part and being connected to the second electrical component, and
wherein the one or more electrical contacts are constrained to move within the respective groove and are urged against the conductive strip of the groove, to thereby establish an electrical connection between the first electrical component and the second electrical component.

31. The device of claim 30, wherein the device is a camera, and the connector is configured to carry imaging signals from the camera and/or commands to the camera.

32. The device of claim 30, wherein the device is a robotic arm or section, and the connector is configured to carry power and control signals to the actuator.

33. A robot arm comprising:
two arm sections;
a ball and socket connector; and
a joint formed between the two arm sections, the joint being connected by the ball and socket connector; and
motors and/or actuators for bending the joint.

34. The robot arm of claim 33, wherein an electrical connection is maintained between a first electrical component and a second electrical component by contact between a conductor on an outer surface of the ball and a conductor on an inner surface of the socket.

35. The robot arm of claim 33, further comprising an electrical connector, the electrical connector comprising:
a first part having a first electrical component; and
a second part having a second electrical component,
wherein one of the first and second parts forms a ball part and the other of the first and second parts forms a socket part, the ball and socket parts being connected together to allow movement with respect to each other thereby permitting variable angles to be defined between an axis of the first electrical component and an axis of the second electrical component,
wherein the first part includes one or more grooves spaced around a surface of the first part, the one or more grooves being lined with or including a conductive strip connected to the first electrical component, and the second part including one or more electrical contacts the one or more electrical contacts configured to extend into a respective groove of the first part and being connected to the second electrical component, and
wherein the one or more electrical contacts are constrained to move within the respective groove and are urged against the conductive strip of the groove, to thereby establish an electrical connection between the first electrical component and the second electrical component.

36. The robot arm of claim 33, wherein the arm sections contain cables for carrying power and signals to the connector and for transmission further down the arm.

37. The robot arm of claim 33, wherein the socket includes T-shaped longitudinal/radial tracks and the ball has grooved tracks.

38. The robot arm of claim 33, wherein the ball contains motors and/or actuators.

39. The robot arm of claim 33, wherein the motors and/or actuators are located in a housing external to the joint.

40. The electrical connector of claim 13, wherein the ball part includes longitudinal walls extending in radial planes that define the grooves as regions between the longitudinal walls.

41. The electrical connector of claim 13, wherein the ball part or the socket part further includes a sliding contact assembly that is configured to allow relative rotation between the first and second electrical components about an axis of the connector.

42. The electrical connector of claim 13, wherein the first or second electrical component is a plug or a socket.

43. The electrical connector of claim 13, further comprising:
a plurality of conductive ball bearings,
wherein the socket part includes a female portion that includes a contact crown having a plurality of elongate electrical contacts, each electrical contact corresponding to a groove, and wherein at least one of the plurality of conductive ball bearings is provided in each groove, and the ball bearings are configured to move along each groove so that an electrical contact is maintained during movement of either of the first and second parts.

44. The electrical connector of claim 13, wherein each electrical contact is includes a spring that forces the electrical contact against the contact strips.

45. The electrical connector of claim 13, wherein the socket part includes a female portion that includes a rim that is planar or castellated.

46. The electrical connector of claim 13, further including a protective outer layer configured to protect a surface of the ball part.

47. The electrical connector of claim 13, wherein one of the first and second electrical components is a headphone jack plug.

48. The electrical connector of claim 13, wherein one of the first and second electrical components is a USB plug or socket.

49. The electrical connector of claim 13, further comprising a locking mechanism configured to lock relative movement of the ball and socket parts.

50. The robot arm of claim 33, further comprising an electrical connector, the electrical connector comprising:
a ball part having a first electrical component;
a socket part having a second electrical component, the ball and socket parts being connected together to allow movement with respect to each other thereby permitting variable angles to be defined between an axis of the first electrical component and an axis of the second electrical component,
wherein the ball part includes at least one groove spaced around a surface of the ball part, the at least one groove being lined with or containing a conductive strip connected to the first electrical component, and the socket part including at least one electrical contact on an inner surface of the socket part that is connected to the second electrical component,
wherein most of a length of the at least one electrical contact is located outside of the ball part so that rotation of the ball-and-socket joint is allowed by the at least one contact riding over the ball part,
wherein the at least one contact has an inwardly extending part, near a free end of the at least one contact, which is constrained to move within the at least one groove and the inwardly extended part is configured to be urged against the conductive strip, to thereby establish an electrical connection between the first electrical component and the second electrical component.

51. The electrical connector of claim 20, wherein the electrical connector includes eight grooves with conductive strips and four electrical contacts.
